(19) United States
(12) Patent Application Publication
(10) Pub. No.: US 2016/0269121 A1
(43) Pub. Date: Sep. 15, 2016

(54) Modulator Biasing For Optical Transmission

(71) Applicant: Alcatel-Lucent USA Inc., Murray Hill, NJ (US)

(72) Inventors: Sian Chong J. Lee, Summit, NJ (US); Noriaki Kaneda, Westfield, NJ (US)

(73) Assignee: Alcatel-Lucent USA Inc., Murray Hill, NJ (US)

(21) Appl. No.: 14/730,782

(22) Filed: Jun. 4, 2015

Related U.S. Application Data
(60) Provisional application No. 62/130,287, filed on Mar. 9, 2015.

(51) Int. Cl. H04B 10/54; H04B 10/524

(52) U.S. Cl. CPC H04B 10/54; H04B 10/524

(57) ABSTRACT

An apparatus includes an optical modulator and an electrical driver. The electrical driver is configured to provide to the modulator an input drive signal comprising multiple input electrical drive levels of a pulse-amplitude modulation (PAM) signal. The electrical driver is further configured to provide unequal spacing between adjacent ones of the multiple input electrical drive levels, and is still further configured to provide a non-zero bias to the input drive signal. The electrical driver may be a component of an optical transmitter, and the input drive signal may be a differential drive signal. The electrical driver may be further configured such that the bias configures the modulator to produce PAM-modulated optical field output levels that are more evenly spaced than the input electrical drive levels.

### CROSS-REFERENCE TO RELATED APPLICATIONS

This application claims the benefit of U.S. Provisional Application Ser. No. 62/130,287 filed on Mar. 9, 2015, commonly assigned with this application and incorporated herein by reference.

### TECHNICAL FIELD

The present invention relates generally to the field of optical communications, and more particularly, but not exclusively, to optical signal modulation.

### BACKGROUND

This section introduces aspects that may be helpful to facilitate a better understanding of the inventions. Accordingly, the statements of this section are to be read in this light and are not to be understood as admissions about what is in the prior art or what is not in the prior art.

Optical transmission with direct detection may enable substantially simpler and lower cost transceiver solutions compared to coherent optical signal detection. Conventional direct detection optical systems employ dual side band (DSB) modulation at the transmitter side, which is limited to short transmission distances due to the inter-play of fiber chromatic dispersion and square-law detection. One modulation scheme in such a case uses, e.g. 4-level pulse-amplitude modulation (PAM-4), limited to between about 2 km and about 10 km in the case of 4×100 GbE. Another modulation scheme is SSB-DMT (single side band discrete multitone).

### SUMMARY

The inventors disclose various apparatus and methods that may be beneficial applied to transmission and reception of optical communications signals. While such embodiments may be expected to provide improvements in performance and/or reduction of cost of such apparatus and methods, no particular result is a requirement of the present invention unless explicitly recited in a particular claim.

In one aspect, an apparatus includes an optical modulator and an electrical driver. The electrical driver is configured to provide to the modulator an input drive signal comprising multiple levels of a pulse-amplitude modulation (PAM) signal. The electrical driver is further configured to provide unequal spacing between adjacent ones of the multiple electrical drive levels, and is still further configured to provide a non-zero bias to the input drive signal. In some embodiments the electrical driver is a component of an optical transmitter. In some embodiments the input drive signal is a differential drive signal.

In various embodiments the electrical driver is further configured such that the bias configures the modulator to produce PAM-modulated optical field output levels that are more evenly spaced than the input electrical drive levels. In some embodiments the modulator comprises a Mach-Zehnder modulator (MZM), and the electrical driver is configured to provide a DC bias to the MZM that is at least about 0.5 times a V, associated with the MZM.

In some embodiments the electrical driver includes a DC bias circuit configured to bias a control input range of the modulator to a nonlinear portion of an optical field transfer function of the modulator. The nonlinear portion may include an endpoint substantially equal to a local maximum output value of the transfer function. The nonlinear portion may also be approximately centered on a point on the transfer function that is at least about 80% of a peak-to-peak range of the transfer function.

In some embodiments the PAM-modulated optical field output levels are more evenly spaced than the input electrical drive levels as determined by a standard deviation of differences between adjacent input electrical drive levels and a standard deviation of differences between adjacent output optical field levels.

In another aspect a method, e.g. a method of manufacture, includes configuring an optical driver to control an optical modulator, e.g. a MZM. The electrical driver is configured to provide to an optical signal modulator an input electrical drive signal comprising multiple levels of a PAM signal. The electrical driver is further configured to provide unequal spacing between adjacent ones of the multiple levels. The electrical driver may include a DC bias circuit configured to provide a non-zero DC bias of the input drive signal. Some embodiments of the method further include configuring the electrical driver such that the bias configures the modulator to produce PAM-modulated optical field output levels that are more evenly spaced than the input electrical drive signal levels.

### BRIEF DESCRIPTION OF THE DRAWINGS

A more complete understanding of the present invention may be obtained by reference to the following detailed description when taken in conjunction with the accompanying drawings wherein:

FIG. 1 illustrates a transmitter, receiver and optical path, wherein the transmitter is configured according to embodiments described herein;

FIG. 2 illustrates a Mach-Zehnder modulator that may be operated in the transmitter of FIG. 1 according to various described embodiments;

FIGS. 3A-3C illustrates aspects of biasing of a Mach-Zehnder modulator for optical intensity modulation, e.g. for DSB-PAM4 modulation;

FIGS. 4A-4C illustrates aspects of biasing of a Mach-Zehnder modulator for optical field modulation, e.g. for SSB-PAM4 modulation;

FIGS. 5A-5C illustrates aspects of biasing of a Mach-Zehnder modulator for optical field modulation at a higher quadrature point than shown in FIG. 4;

FIGS. 6A-6C illustrates additional aspects of the Mach-Zehnder transfer function shown in FIG. 5A, with electrical pre-distortion of the electrical driver input;

FIGS. 7A and 7B illustrate DSP convergence results without (7A) and with (7B) electrical predistortion as exemplified by FIG. 6B; and

FIG. 8A-8C shows measured bit error rate (BER) for electrical predistortion optimized for zero km transmission distance and for 80 km transmission distance.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

SSB-DMT modulation may be deficient for some applications due to typically required high resolution digital-to-analog converters (DACs) and linear drivers, which result in relatively higher power consumption of the transceiver module than similar transceivers that do not require such devices. Also the peak to average ratio of DMT modulation is typically worse than PAM, which results in narrower dynamic range and reduced link budget. Moreover, the nonlinear pre-distortion in DMT modulation is generally not straightforward to implement. Furthermore, typical direct detection optical systems employ DSB modulation at the transmitter side, which is inherently limited to relatively short transmission distances due to the inter-play of fiber chromatic dispersion and square-law detection. In one example, 4-level pulse-amplitude modulation (PAM-4) is generally considered to be limited to a maximum transmission distance of between about 2 km and about 10 km for the case of 4×100 GbE.

In some cases the distance limitation of direct detection, e.g. using DSB modulation, can be avoided using SSB modulation combined with digital signal processing at the receiver side. Best performance typically results when high optical transmitter output power can be achieved, such that the driving laser operates as a self-coherent carrier. This implies that the optical modulator has to be modulated in its nonlinear region. But such operation may be detrimental to fidelity of the transmitted symbol constellation, as such nonlinearity reduces noise margins between symbol points in the constellation thereby increasing BER at a given transmission distance, or conversely reducing the maximum transmission distance for a given BER.

The inventors have determined that the aforementioned issues related to operation of the modulator in a nonlinear regime may be substantially reduced by applying pre-distortion to the electrical-domain signal driving the modulator, e.g. a Mach Zehnder modulator. For instance, predistortion may scale the modulator drive signal in such a way that the modulator output is substantially similar to the output that results when operating the modulator in its linear regime without drive signal predistortion. Thus the benefits of co-propagating high carrier power may be realized without nonlinearities of the transmitted signal that would otherwise reduce the transmission distance.

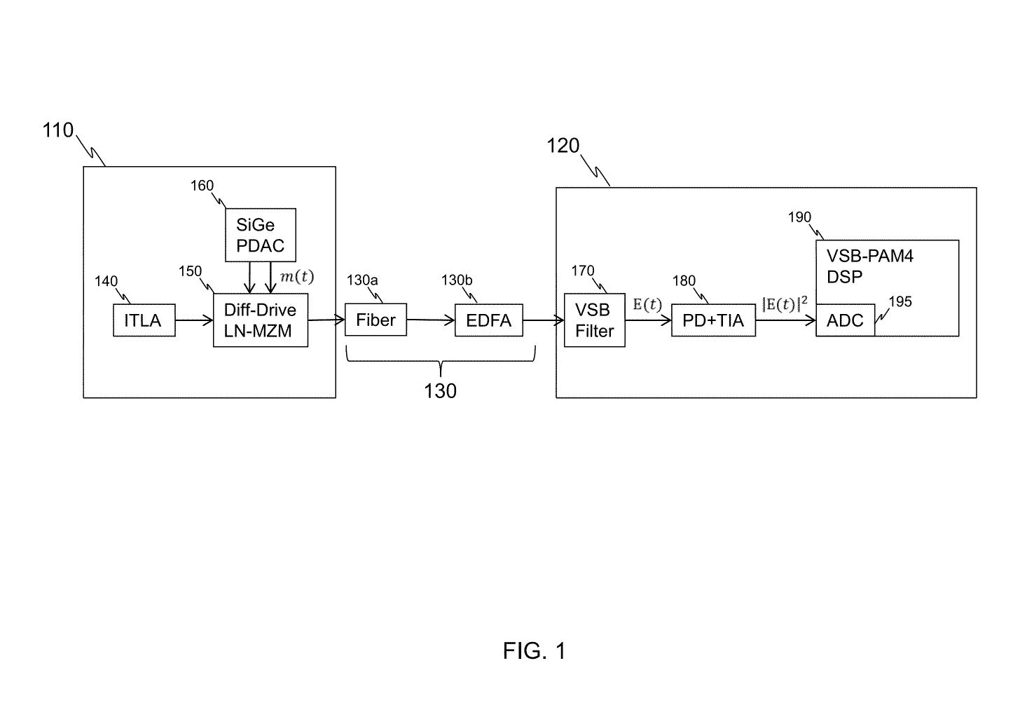

Turning initially to FIG. 1, a schematic diagram is shown of a system 100, e.g. a metro optical communication link, configured to operate consistent with embodiments of the disclosure. The system 100 includes a transmitter 110, a receiver 120, and an optical link 130 connected therebetween. The transmitter 110 includes an optical source 140, e.g. an integrable tunable laser assembly (ITLA), and a modulator 150, e.g. a Mach-Zehnder modulator (MZM) that receives the optical source 140 output. The modulator 150 may be implemented in, e.g. silicon photonics, e.g. InP or lithium niobate (LiNbO₃). The modulator 150 also receives a drive signal m(t) from an electrical driver 160, e.g. a PDAC (photonic digital to analog converter), and directs a modulated optical signal toward the optical link 130. The electrical driver may include any combination of analog and/or digital circuit elements configured to provide a static (e.g. DC), optionally adjustable, bias and a dynamic (e.g. AC) drive signal to the modulator 150. The optical link 130 may include an optical fiber 130a and an amplifier 130b, e.g. an EDFA (erbium-doped fiber amplifier). The optical link 130 may have a length between about zero and about 80 km, e.g. as may be applicable to metro optical communication links.

The receiver 120 receives the modulated optical signal via a filter 170, e.g. a single-sideband (SSB) filter or a vestigial sideband (VSB) filter, which outputs a filtered optical-domain signal E(t). An optical-to-electrical (OE) transducer 180, e.g. comprising a photodiode detector and a transimpedance amplifier, converts the filtered optical signal to an electrical-domain modulated intensity signal |E(t)|². A receiver processor 190, e.g. a digital signal processor (DSP), receives the output of the transducer 180 via an analog to digital converter (ADC) 195 that converts the electrical-domain modulated signal to a digital-electrical representation.

FIG. 1 shows without limitation an embodiment that uses the VSB filter 170 located at the receiver 120. In other embodiments the filter 170 may be located within the optical link 130 or within the transmitter 110. Moreover, while in the illustrated embodiment the filter 170 is described as a VSB filter, in some embodiments a SSB filter may be used. The role of the filter 170 is described below. In various embodiments of the transmitter 110, the electrical driver 160 is configured to provide a differential drive signal to the modulator 150 to modulate the optical carrier with four-level pulse amplitude modulation (PAM4) format.

The following equations and related discussion describe a transmission model of the system 100. This discussion is presented as an aid to understanding certain issues relating to the operation of the system 100 as best understood by the inventors. No limitations are intended nor disclaimers made regarding the scope of the written description and claims by this discussion.

The signal received by the receiver 120 is initially received by the filter 170. The following analysis assumes without limitation that the filter 170 is implemented by a VSB filter. The output of the filter 170 may be represented by Eq. 1 below, which includes a single side-band signal component [m(t)+j\hat{m}(t)].

E(t)={1+α[m(t)+j\hat{m}(t)]}·e^{jω}^{₀}^{t}, for 0<α≦0.5 (1)

where \hat{m}(t) is the Hilbert transform of m(t),

ωₒ is the optical carrier frequency, and

1/α is the carrier-to-signal ratio.

After the transducer 180, the detected signal, |E(t)|², may be expressed as

$$\begin{matrix}\vert E ( t ) {\vert}^{2} = E ( t ) \cdot {E}^{*} ( t ) & ( 2 ) \\ = \{ 1 + α [ m ( t ) + j \hat{m} ( t ) ] \} \cdot {e}^{j {ω}_{0} t} \cdot \{ 1 + α [ m ( t ) - j \hat{m} ( ) t ) ] \} \cdot {e}^{- j {ω}_{0} t} & ( 3 ) \\ = 1 + 2 α m ( t ) + {α}^{2} [ {m}^{2} ( t ) + {\hat{m}}^{2} ( t ) ] & ( 4 )\end{matrix}$$

The expression [m² (t)+\hat{m}²(t)]) in Eq. 4 represents a residual nonlinear distortion component of the detected signal that may be compensated for by compensation algorithms performed by the processor 190.

In some embodiments the optical filter 170 is omitted in lieu of an I-Q modulator such as described in X. Xu, et al., “Advanced modulation formats for 400-Gbps short-reach optical inter-connection”, Optics Express 23.1 (2015): 492-500, incorporated herein by reference in its entirety. However, such embodiments generally use a look-up table for the nonlinear pre-distortion and are expected to be more complex to implement. When the optical filter 170 is used, the nonlinear pre-distortion as described herein may be implemented without significant technical difficulty. Embodiments described below are presented without limitation using the filter 170 in the receiver 120.

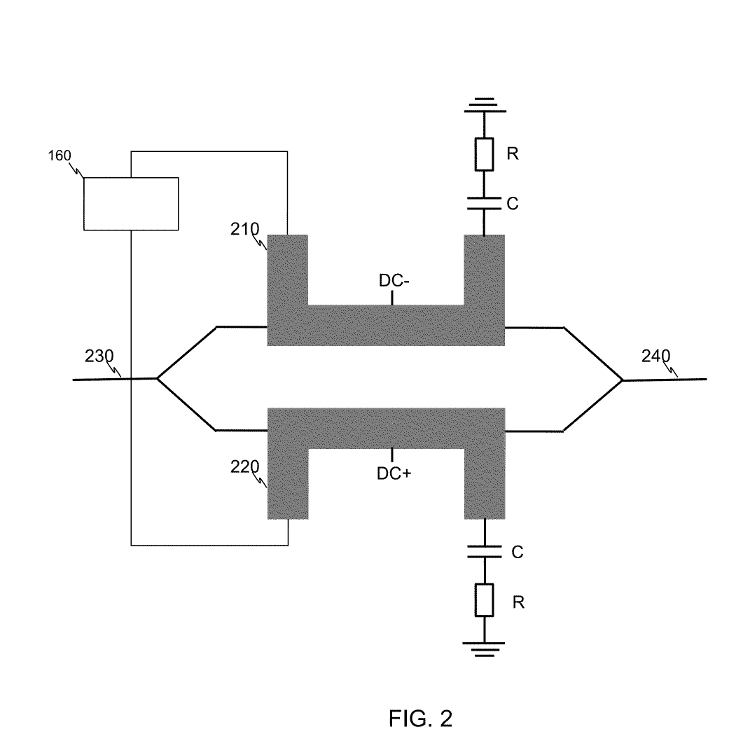

FIG. 2 shows a schematic illustration of the modulator 150, e.g. a MZM. The electrical driver 160 is shown as providing an AC component and a DC component (bias) to electrodes 210, 220. While the illustrated configuration provides differential excitation of the electrodes 210, 220, other embodiments may use single-ended excitation of one of the electrodes. Voltage applied to the electrodes causes the modulator 150 to modulate an incoming optical signal 230, e.g. from the optical source 140, and to produce a modulated signal 240, e.g. a PAM4 signal.

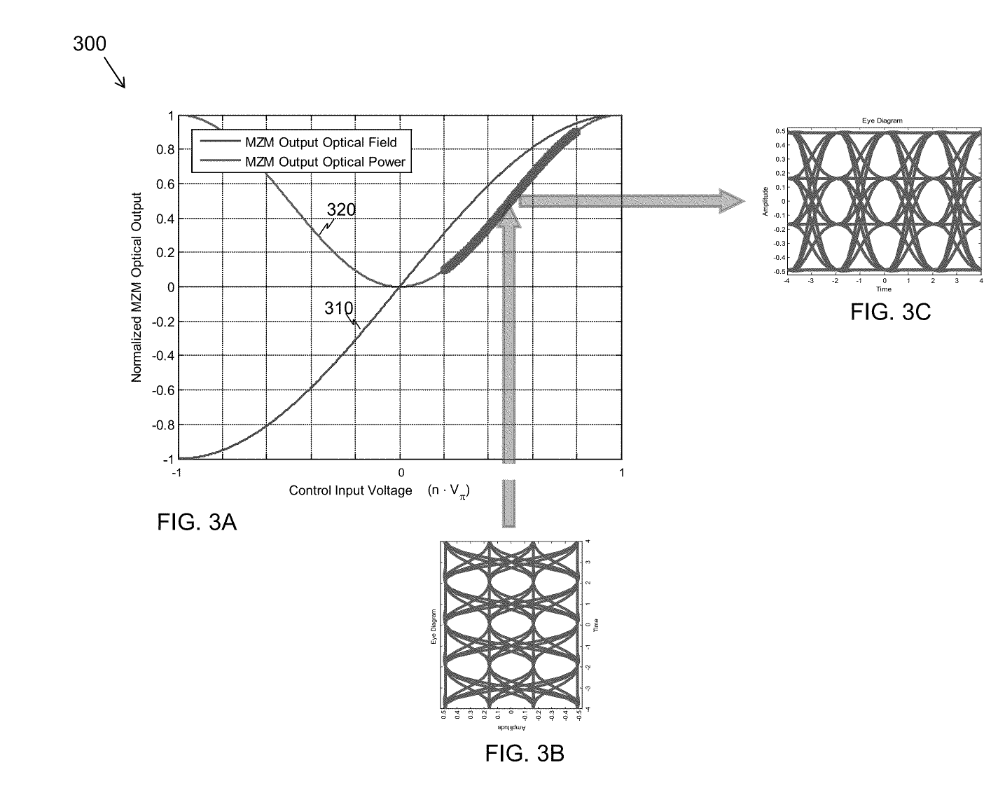

FIGS. 3A-3C illustrate aspects of the operation of the modulator 150. A transfer function 310 (FIG. 3A) describes the modulator 150 output optical field ranging between ±1 (normalized output) as a function of the control input voltage applied to the electrodes 210, 220 ranging from about −V_{π}. to about V_{π}. Those skilled in the pertinent art will appreciate that V_{π} is the voltage at which a modulator such as a MZM effects a relative phase shift π between signal components propagating through each arm of the MZM. A transfer function 320 describes the output optical power (intensity) ranging between zero and unity as a function of the DC bias. Conventionally, when operating the modulator 150 for DSB-PAM4 transmission, a receiver is configured to detect the intensity of the received signal. Thus, in such cases, the MZM is typically configured to operate within a relatively linear portion of the transfer function 320, and shown in FIG. 3A. FIG. 3B describes an eye diagram of the electrical driver signal used to modulate the modulator 150, resulting in a modulated optical intensity eye diagram shown in FIG. 3B. The result is a symmetric 4-level modulation in optical intensity.

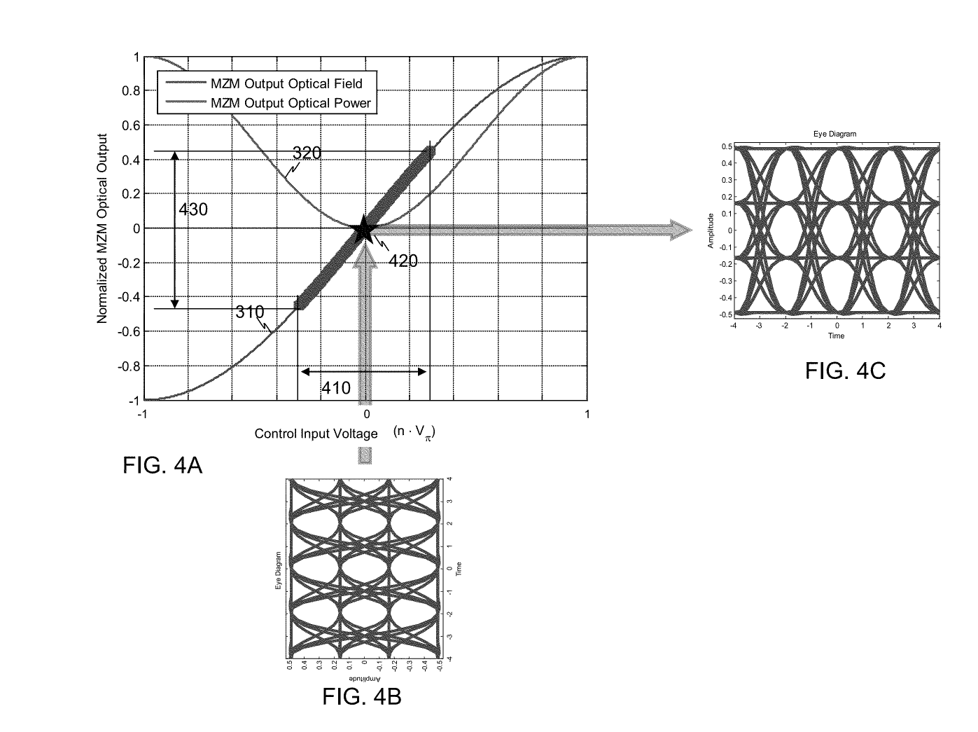

FIGS. 4A-4C illustrates the case for which the modulator 150 is configured to conventionally operate for SSB-PAM4 modulation. In this case the received optical field is detected at the receiver, while the modulator 150 is operated in a relatively linear portion optical field modulation transfer function 310, e.g. the zero DC bias. It will be appreciated by those skilled in the pertinent art that a function such as transfer function 310 at least approximates a sinusoidal function. The highlighted portion of the function 310, e.g. with control input voltage ranging from about −0.3·V_{π} to +0.3·V_{π}, represents a relatively linear portion of the sinusoidal function. As described with respect to the optical intensity modulation of FIGS. 3A-3C, a symmetrical modulated electrical eye diagram of FIG. 4B results in a symmetrical modulated optical field eye diagram of FIG. 4C.

Referring to FIG. 4A, some aspects of nomenclature are illustrated for reference in this discussion. A control input range 410 is defined by the extent of the control input voltage corresponding to the highlighted portion of the function 310. A DC bias 420 is located at the midpoint of the control input range 410, e.g. the average of the minimum and maximum values of the control input range 410. A normalized output range 430 is bounded by a maximum normalized optical output corresponding to the maximum value of the control input range, and by a minimum normalized optical output corresponding to the minimum value of the control input range. While these features are indexed in FIG. 4A, they are referred to without indexes in the following discussion in recognition of their descriptive purpose.

Linearity of the transfer function 310 within the control input range may be determined using statistical techniques. For example, a sufficient number of points, e.g. 5-10, may be calculated from the sinusoidal function, e.g. sin(x), about evenly spaced in the control input voltage range of interest. In the present discussion the control input voltage range ±π is divided into ten portions, so the linearity is determined for a control input range of π/5. The calculated points may be distributed in this range and include the end points of the range. A linear fit may be performed on the calculated points, and a coefficient of determination, R², determined for the resulting linear equation, where an R² value of unity would indicate a perfect fit to the sample points. In the example above of a control input range of ±0.1·V_{π} around a DC bias of zero, R²≈0.9999. For the purposes of this discussion and the claims, a portion of the transfer function 310 is regarded as “linear” when a linear fit to the points within that portion results in R² equal to or greater than 0.993, which corresponds to a control input voltage of between 0.6·V_{π} and −0.6·V_{π}. Thus the function 310 is considered “nonlinear” when the control input voltage is greater than about 0.6·V_{π} or less than about −0.6·V_{π}.

While the zero DC bias may be desirable for linear field detection, for direct detection system co-propagating carrier power is typically needed to mix with the modulated signal. Such power may be supplied by a co-propagating unmodulated carrier signal, or by a DC component of the modulated output of the modulator 150. The latter option may be desirable in that it allows a simpler system design. In such cases it is therefore desirable to add a nonzero DC bias to shift the control input range of the modulator 150 toward V_{π}, e.g. toward the peak of the optical field transfer function 310. Such operation may better utilize the laser power as a self-coherent carrier.

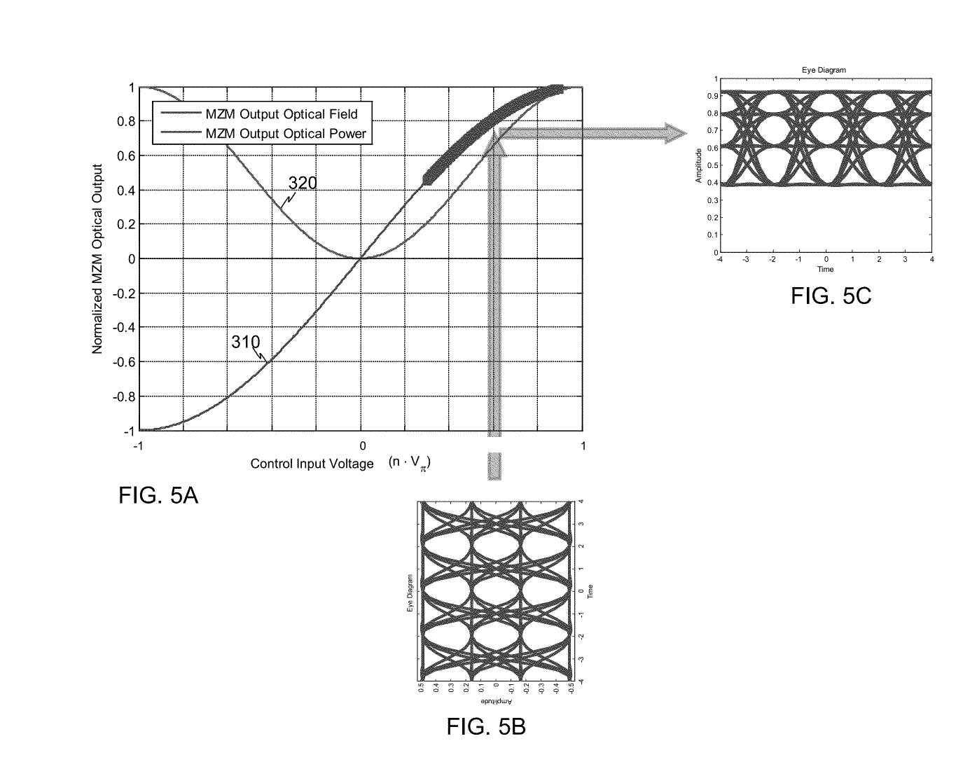

FIGS. 5A-5C show the transfer function 310 with the addition of a nonzero DC bias. In some such embodiments the DC bias of the MZM is at least about 0.5·V_{π}. For example, in the illustrated nonlimiting embodiment, the DC bias is about 0.6·V_{π}. In contrast to FIG. 4A, the highlighted portion of the transfer function 310 corresponds to a control input range from about 0.3·V_{π} to about 0.9V_{π}, or a total range of about 0.6·V_{π}. This range includes a portion of the transfer function 310 for which the control input voltage is greater than 0.6·V_{π}, which as defined above is a nonlinear portion of the transfer function 310. Furthermore, the highlighted portion of the transfer function 310 includes an endpoint that is substantially equal to a local maximum output value of the transfer function 310. In the illustrated example, the normalized output value of the transfer function 310 is about 0.994 at an control input range of about 0.9·V_{π}, compared to unity at V_{π}. The normalized output value at V_{π} is the maximum value in the displayed range, and may also be regarded as a local maximum due to the periodic nature of the sinusoidal function. For the purposes of this discussion and the claims, the endpoint of the highlighted range of the transfer function 310 is defined as being substantially equal to a local maximum output value of the transfer function 310 when the normalized output value at the endpoint is at least about 0.99, corresponding in the illustrated example to a control input voltage of about 0.9·V_{π} or greater.

Comparing FIGS. 5B and 5C, the symmetric input eye diagram of FIG. 5B results in an asymmetric, i.e., distorted, output optical field eye diagram of FIG. 5C. Such asymmetry is expected to result in higher BER of a transmitted signal for a fixed transmission distance, or conversely a lower transmission distance for a fixed BER. The effect of this asymmetry may be substantially reduced by predistorting the drive signal to the modulator 150.

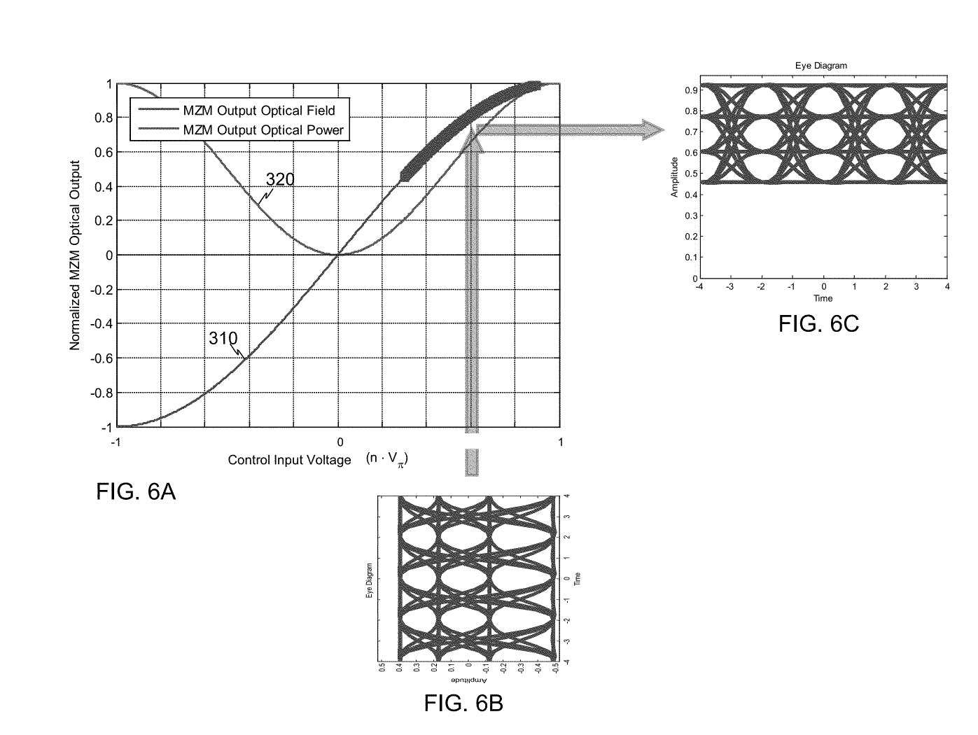

Viewing FIGS. 6A-6C, the output of the modulator 150 is described, according to one embodiment, with addition of electrical pre-distortion of the modulator control signals. FIG. 6B presents a predistorted electrical eye diagram. When the predistorted signal is mapped to the transfer function 310, the output optical field eye diagram of FIG. 6C results. In FIG. 6A, the control input voltage of the drive signal ranges from about 0.3·V_{π} to about 0.9·V_{π}, with a DC bias of about 0.6·V_{π}. Of course, the control drive signal range and DC bias may have other values, with a higher DC bias generally providing greater self-coherence, and the drive signal range generally determining the spacing between transmitted symbols. It is evident by inspection that the eye diagram of FIG. 6C is relatively symmetric, e.g. undistorted, comparing favorably with the eye diagram of FIG. 3C that results using the linear portion of the transfer function 310. Moreover, it is evident that the PAM-modulated optical field output levels are qualitatively more evenly spaced than the input drive levels. Any remaining distortion, e.g. as described by the residual nonlinear distortion component of Eq. 4, is expected to be within the capability of the processor 190 to compensate.

In a nonlimiting example, the evenness of spacing of input electrical drive levels and output optical levels may be determined quantitatively as follows. The input electrical drive levels may be determined from FIG. 6B, e.g. resulting in a set approximately represented by [0.4 0.18 −0.12 −0.49]. Corresponding differences between adjacent electrical input levels are [0.22 0.30 0.37], with standard deviation of about 0.08. The output optical field levels may be determined from FIG. 6C, e.g. resulting in a set approximately represented by [0.92 0.78 0.60 0.46]. Corresponding differences between adjacent output optical field levels are [0.14 0.18 0.14], with standard deviation of about 0.02. The lower standard deviation of the optical field levels demonstrates the greater evenness of the optical field levels as compared to the input electrical drive levels.

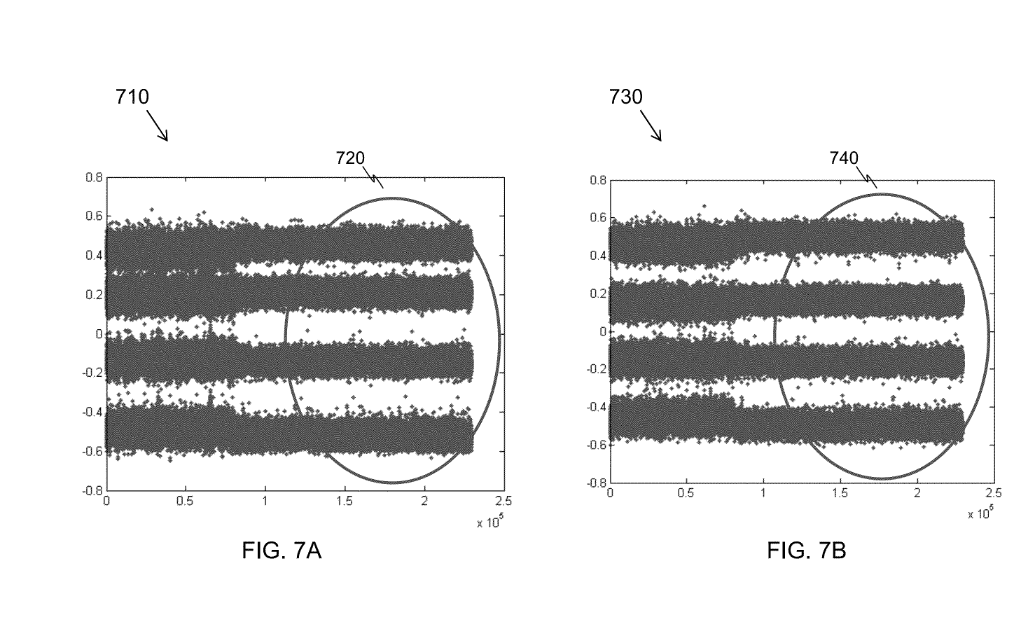

The benefit of described embodiments is illustrated by comparison of FIGS. 7A and 7B, which each display received symbol constellations, with the number of received symbols increasing along the horizontal axis, and the received symbol amplitude increasing along the vertical axis. FIG. 7A represents a received symbol constellation 710 for the case of the modulator 150 biased as described by FIG. 5A, but without electrical predistortion, and a transmission distance of about 80 km. The modulation levels of the control signals from the electrical driver 160 are about [3 1 −1 −3] (arbitrary units). A region 720 represents the constellation after a sufficient number of received symbols to stabilize software compensation of residual distortion, e.g. as described by the residual nonlinear distortion component of Eq. 4. Inspection of FIG. 7A in the region 720 reveals unequal spacing between adjacent symbol amplitudes consistent with the optical field eye diagram of FIG. 5C. The unequal spacing is expected to cause a significant signal-to-noise ratio (SNR) penalty. FIG. 7B represents a received symbol constellation 730 for the case of the modulator 150 biased as described by FIG. 5A, but including electrical predistortion, such as described with respect to FIG. 6B. The modulation levels of the control signals from the electrical driver 160 are about [3 0.5 −1.25 −3]. A region 740 represents the constellation after a sufficient number of received symbols to stabilize software compensation of residual distortion, e.g. as described by the residual nonlinear distortion component of Eq. 4. Inspection of FIG. 7B in the region 740 reveals approximately equal spacing between adjacent symbol amplitudes consistent with the optical field eye diagram of FIG. 6C. Moreover, the spacing of the output levels in the region 740 is more evenly spaced than the input drive levels [3 0.5 −1.25 −3].

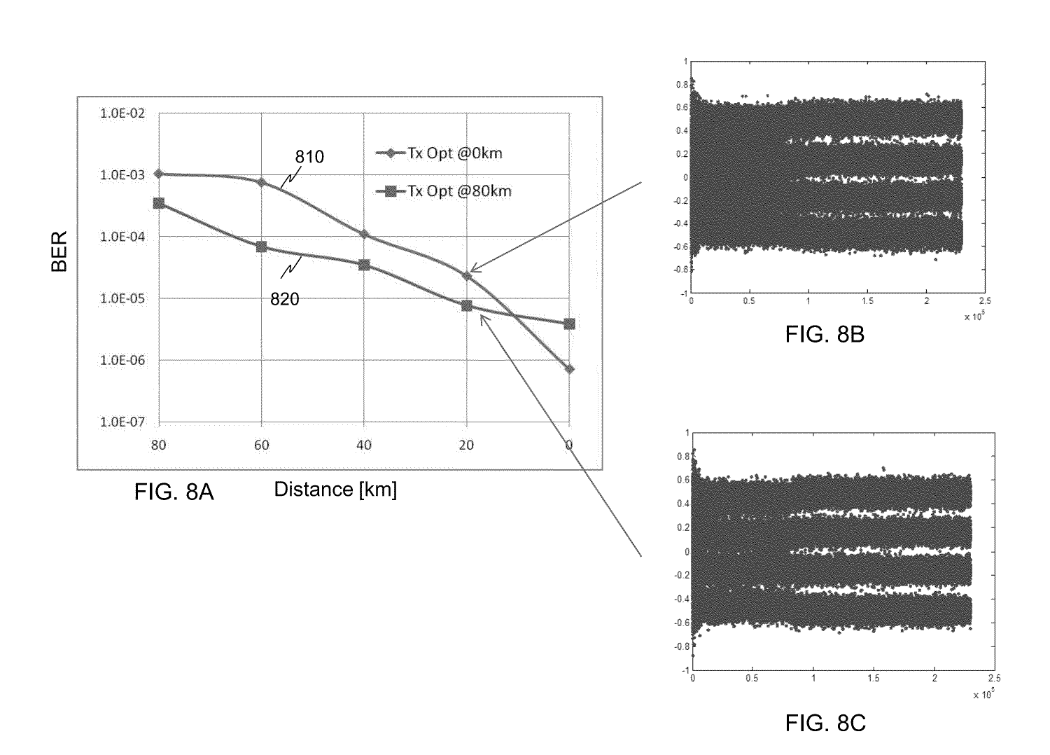

FIGS. 8A-8C describe another view of the beneficial results of at least one described embodiment. FIG. 8A includes characteristics 810 and 820 that describe BER with decreasing transmission distance from 80 km to 0 km. The characteristic 810 and FIG. 8B represent the case in which the predistortion is optimized for lowest BER at 0 km transmission distance but no electrical predistortion, whereas the characteristic 820 and FIG. 8C represent the case in which the predistortion is optimized for lowest BER at 80 km, and using electrical predistortion. Inspection of the characteristics 810 and 820 make clear that under these nonlimiting sample conditions the BER of the system 100 using electrical predistortion and optimized for 80 km transmission distance is lower above about 10 km transmission distance. This comparison shows the clear benefit of the described embodiments, at least for the described conditions.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, DSP hardware, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, in conjunction with the appropriate computer hardware, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

1. An apparatus, comprising:
a optical signal modulator; and
an electrical driver configured to provide to said modulator an input drive signal comprising multiple input electrical drive levels of a pulse-amplitude modulation (PAM) signal,
wherein said electrical driver is further configured to:
provide unequal spacing between adjacent ones of said multiple input electrical drive levels; and
provide a non-zero bias to said input drive signal.

2. The apparatus of claim 1, wherein said electrical driver is further configured such that said bias configures said modulator to produce PAM-modulated optical field output levels that are more evenly spaced than said input electrical drive levels.

3. The apparatus of claim 1, wherein said modulator comprises a Mach-Zehnder modulator (MZM) and said electrical driver is configured to operate said MZM with a DC bias that is at least about 0.5 times a V_{π} associated with said MZM.

4. The apparatus of claim 1, wherein said electrical driver is configured to bias a control input range of said modulator to a nonlinear portion of an optical field transfer function of said modulator.

5. The apparatus of claim 4, wherein said nonlinear portion includes an endpoint substantially equal to a local maximum output value of said transfer function.

6. The apparatus of claim 4, wherein said nonlinear portion includes a point at least about 98% of a normalized maximum of said transfer function.

7. The apparatus of claim 4, wherein said nonlinear portion includes a point at least about 95% of a normalized maximum of said transfer function.

8. The apparatus of claim 2, wherein said PAM-modulated optical field output levels are more evenly spaced than the input electrical drive levels as determined by a standard deviation of differences between adjacent input electrical drive levels and a standard deviation of differences between adjacent output optical field levels.

9. The apparatus of claim 1, wherein said electrical driver is a component of an optical transmitter.

10. The apparatus of claim 1, wherein said input drive signal is a differential drive signal.

11. A method, comprising:
configuring an electrical driver to provide to an optical signal modulator an input electrical drive signal comprising multiple levels of a pulse-amplitude modulation (PAM) signal; and
configuring said electrical driver to provide unequal spacing between adjacent ones of said multiple levels; and
configuring said electrical driver to provide a non-zero bias to said input drive signal.

12. The method of claim 11, further comprising configuring said electrical driver such that said bias configures said modulator to produce PAM-modulated optical field output levels that are more evenly spaced than said input electrical drive signal levels.

13. The method of claim 11, wherein said modulator comprises a Mach-Zehnder modulator (MZM), and further comprising configuring said electrical driver to provide a DC bias to said MZM that is at least about 0.5 times a V_{π} associated with said MZM.

14. The method of claim 11, wherein said electrical driver is configured to bias a control input range of said modulator to a nonlinear portion of an optical field transfer function of said modulator.

15. The method of claim 14, wherein said nonlinear portion includes an endpoint substantially equal to a local maximum output value of said transfer function.

16. The method of claim 14, wherein said nonlinear portion includes a point below a local maximum of said transfer function within a range of about 98% to about 100% of a normalized maximum of said transfer function.

17. The method of claim 14, wherein said nonlinear portion includes a point below a local maximum of said transfer function within a range of about 95% to about 100% of a normalized maximum of said transfer function.

18. The method of claim 12, wherein said PAM-modulated optical field output levels are more evenly spaced than said input electrical drive levels as determined by a standard deviation of differences between adjacent input electrical drive levels and a standard deviation of differences between adjacent output optical field levels.

19. The method of claim 1, wherein said electrical driver is a component of an optical transmitter.

20. The method of claim 1, wherein said input drive signal is a differential drive signal.
